(19) United States
(12) Patent Application Publication
(10) Pub. No.: US 2019/0179620 A1
(43) Pub. Date: Jun. 13, 2019

(54) Modular Web Content Software Architecture

(71) Applicant: PAYPAL, INC., San Jose, CA (US)

(72) Inventors: Justin Scott Lowery, Round Rock, TX (US); Frank Anthony Nuzzi, Pflugerville, TX (US)

(21) Appl. No.: 15/886,570

(22) Filed: Feb. 1, 2018

Related U.S. Application Data
(63) Continuation-in-part of application No. 15/835,055, filed on Dec. 7, 2017.

(51) Int. Cl. G06F 8/35; G06F 17/30; G06F 8/65; G06F 11/07

(52) U.S. Cl. CPC G06F 8/35; G06F 17/30893; G06F 8/65; H04L 67/02; G06F 11/0781; G06F 11/0793; G06F 11/0709

(57) ABSTRACT

A software architecture is disclosed that provides a more efficient, safe, and re-usable way of generating internet web content. Using a modular web content architecture, independent renderable content modules can be separated out from a main web application such that the modules function as discrete units that are not directly dependent on the web application itself. This organization can be implemented using a module bundler and/or a mid-tier service to provide enforced separation between the independent renderable content modules and the front-end web application. The software architecture discussed herein provides more sophisticated error handling and better flexibility for creating, maintaining, and updating web applications.

### RELATED APPLICATIONS

This application is a continuation-in-part of, and claims priority to, U.S. patent application Ser. No. 15/835,055, filed Dec. 7, 2017 and entitled Dynamic Web Content Based on Contextual Profile, the contents of which are herein incorporated by reference in their entirety.

### TECHNICAL FIELD

This disclosure relates to a software architecture usable to build web pages via a web application and a content module bundler, according to various embodiments.

### BACKGROUND

Hypertext Markup Language (HTML) and computer languages such as JavaScript are frequently used to construct web pages. As web pages have evolved, their underlying source code has gotten more complicated and offered an increasing array of functionality.

With increased complexity, designing, implementing, and updating web applications has also become increasingly cumbersome and difficult. An error in the source code of one area of a web application can render the application partially or totally unusable, for example, even if such an error relates to only a small portion of the web application. Further, tight integration of content with functionality and design may tend to increase the software testing burden when making updates to a web application (particularly for applications with multiple functionalities).

### BRIEF DESCRIPTION OF THE DRAWINGS

FIG. 1 illustrates a block diagram of a system that relates to a modular content architecture allowing various web content to be bundled in such a way that a front-end web application may have less dependencies and can be more easily managed, according to some embodiments.

FIG. 2 illustrates a block diagram of a system including a variety of computer systems usable with the software architecture of FIG. 1, according to various embodiments.

FIG. 3 illustrates a flow diagram of a method that relates to constructing a web page using a modular web content architecture, according to some embodiments.

FIG. 4 is a diagram of a computer readable medium, according to some embodiments.

FIG. 5 is a block diagram of a system, according to some embodiments.

### DETAILED DESCRIPTION

A web application may include one or more web pages that feature various content and functionality. Various software architectures can be used to service a web page request.

One extremely basic method is to simply serve a static web page to the user. A static web page may generally only be changed in response to manual editing. The modern Internet, however, has feature-rich web pages that include programming elements and dynamically generated text, images, and other data.

A web application may therefore have programming code that dictates its style and layout. The web application may make data requests to a data source, such as an SQL or other database, to generate content for the end user.

Changing such a web application may require editing scripting code in one or more locations. Such edits can have negative consequences, including breaking functionality of one or more portions of the web application. Even when attempting to design or modify one particular portion of a web application (e.g. one or more specific web pages), there is no guarantee that other portions of the web application will not be negatively impacted.

The present specification, however, features a modular web content architecture that separates out the responsibility of rendering certain content to a user into different independent renderable content modules. A front-end application can call on a module bundler application to provide self-contained portions of content (e.g. modules) that adhere to a particular architectural format used by both the front-end application and the module bundler. The module bundler delivers one or more independent renderable content modules to the front-end application, which can then easily integrate the content modules into a web page. The front-end application may not need to worry about error handling or whether some effect within an independent renderable content module could cause an impact on another unrelated portion of the front-end application. This structure provides a useful way to provide and update web content.

Such an architecture can be even more beneficial in larger web applications that may be maintained by many different development teams. Consider a web page that supports five different functionalities as implemented by five different software development teams. Without a modular content architecture, any time one of these software teams makes a change, the remaining four teams may all need to perform verification and testing that the change does not cause any errors for the other functionalities. Such testing can be expensive and time consuming. With a modular content architecture, however, there is no such need for testing in various embodiments. If an independent renderable content module is used to encapsulate functionality, then it may be sufficient to simply do software testing only within that module (and without the need to involve other software development teams). This approach allows for faster and more reliable web software development. Note that the phrases “independent [and] renderable”, as referring to a content module, refers in various embodiments to the fact that the content module is not dependent on a particular front-end web application, and contains the ability to self-render. A specific content module may be independent from a front-end application, for example, because that content module is self-contained in such a way that it does not require particular settings or operations from the front-end application in order to be successfully included in a web page (and to render its content).

This specification includes references to “one embodiment,” “some embodiments,” or “an embodiment.” The appearances of these phrases do not necessarily refer to the same embodiment. Particular features, structures, or characteristics may be combined in any suitable manner consistent with this disclosure.

“First,” “Second,” etc. As used herein, these terms are used as labels for nouns that they precede, and do not necessarily imply any type of ordering (e.g., spatial, temporal, logical, cardinal, etc.).

Various components may be described or claimed as “configured to” perform a task or tasks. In such contexts, “configured to” is used to connote structure by indicating that the components include structure (e.g., stored logic) that performs the task or tasks during operation. As such, the component can be said to be configured to perform the task even when the component is not currently operational (e.g., is not on). Reciting that a component is “configured to” perform one or more tasks is expressly intended not to invoke 35 U.S.C. § 112(f) for that component.

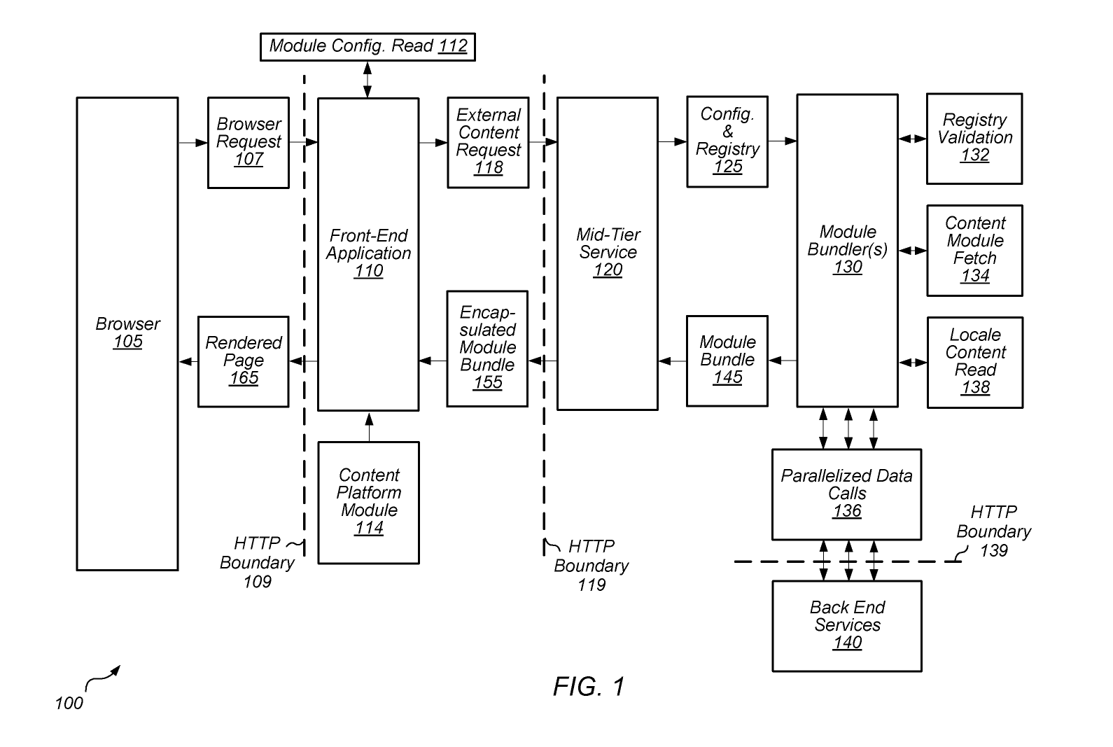

Turning to FIG. 1, a block diagram of a system 100 is shown, according to some embodiments. System 100 relates to a modular content architecture that allows various web content to be bundled in such a way that a front-end web application may have less dependencies and can be more easily managed, in various embodiments.

As shown, system 100 includes browser 105, front end application 110, mid-tier service 120, and module bundle(s) 130. Browser 105 may be a web browser of a user, such as GOOGLE CHROME™, APPLE SAFARI™, MICROSOFT INTERNET EXPLORER™, etc. More broadly, browser 105 may be any software application that allows web content to be viewed on a computing device (e.g. browser 105 could also include smartphone applications that support ANDROID WEBVIEW™ or another way to view web content, for example). Browser 105 makes a browser request 107 to front-end application 110, as shown. This may be a hyper-text transfer protocol (HTTP) request, in various embodiments, such as a request for a particular web page or other resource.

Front-end application 110 is a web application in various embodiments, and may be implemented by one or more web servers. Such web applications can have a variety of functionality, including displaying text and media (e.g. images, sound, videos), receiving user input, etc. Web applications can be implemented in a variety of languages, including HTML, JavaScript, PHP, Java, etc.

In some instances, front-end application 110 may perform a module configuration read 112. This operation may include reading one or more configuration files for the front-end application to determine what independent renderable content modules will be requested by the front-end application, and/or additional configuration information for those modules. In one instance, a configuration file might resemble the following format

$$\begin{matrix}\text{[ \{} & \text{name: “user\_balance\_information”,} \\ & \text{column:} “ A ” , \\ & \text{promo: true\}} \\ \{ & \text{name: “recent\_transactions”,} \\ & \text{column:} “ B ” , \\ & \text{promo: false\}} ]\end{matrix}$$

In this brief example, there are two independent renderable content modules used by the front-end application. The names of these modules may be arbitrary, but serve to identify the module to module bundler(s) 130 in various embodiments. “Column” refers to an A or B column in this example, where the first independent renderable content module will be displayed in column A (e.g., a first column) while the second listed independent renderable content module will be displayed in column B (e.g. a second column adjacent to the first column). Various different layout types are possible, however, and are not confined to simply having two columns. The “promo” attribute also indicates whether promotional content (e.g. advertising) should be included within a particular module, in this example. As will be appreciated, different attribute information may be used within module configuration information in various embodiments (for layout/placement, and for other factors as well). Front-end application 110 may also receive required dependencies for server-side rendering from content platform module 114 in some embodiments. Such dependencies can include library or other dependencies (e.g. a cascading style sheets (CSS) dependency listing one or more particular files, a JavaScript functions library dependency listing one or more particular files, etc.) Thus, in some instances, extended functionality beyond content rendering can be provided to a front-end application via content platform module 114.

Front-end application makes an external module request 118 to mid-tier service 120, in various embodiments, as an HTTP formatted request. The external module request may specify the identities of independent renderable content modules to be retrieved (e.g. user_balance_information, recent_transactions, etc.).

Front-end application also delivers rendered page 165 to browser 105 in response to browser request 107 in various embodiments. This rendered page includes all necessary markup, code, text, images, etc. necessary to display a web page for the user on browser 105. The rendered page may therefore include a variety of different elements inside it that reflect included independent renderable content modules, as well as any additional content made directly available via front-end application 110. For example, a web page format may be defined by front-end application 110 (and can be stored in content platform module 114 in some cases).

Mid-tier service 120, in various embodiments, includes a software application that that interacts with module bundler(s) 130. For example, mid-tier service 120 may pass configuration and registry information 125 to a module bundler, and may also receive back a module bundle 145 from a module bundler. The module bundle may contain a group of one or more independent renderable content modules, as prepared by module bundler(s) 130 (e.g. including localized content, data retrieved from back end services 140, formatting and/or code for execution, etc.).

Module bundler(s) 130 includes one or more module bundlers, in various embodiments. A module bundler may take particular operations relative to one or more independent renderable content modules. These operations may include registry validation 132, making a content module fetch 134, and performing a locale content read 138 in various embodiments (e.g., reading an appropriate locale file for a user's request). A module bundler may also make parallelized data calls 136 to back end services 140. These parallelized data calls can include one or more requests sent to one or more databases to retrieve data necessary to build a content module and/or display information within the content module when it is rendered on a web page.

HTTP boundaries 109, 119, and 139 are also illustrated in FIG. 1. These boundaries denote that communication is passed via HTTP (e.g. over a network between different systems) in various embodiments. Note that other protocols could be used if desired, however. Further, in some instances, one or more of these HTTP boundaries could be omitted. However, in various embodiments, HTTP boundaries 109, 119, and 139 help enforce the separation in functionality provided by browser 105, front-end application 110, mid-tier server 120 and module bundler(s) 130, and back end services 140. Note that one or more additional HTTP (or another communication protocol) boundaries can also be placed within the architecture of FIG. 1 (such as between mid-tier service 120 and module bundler(s) 130, if desired, or in other locations).

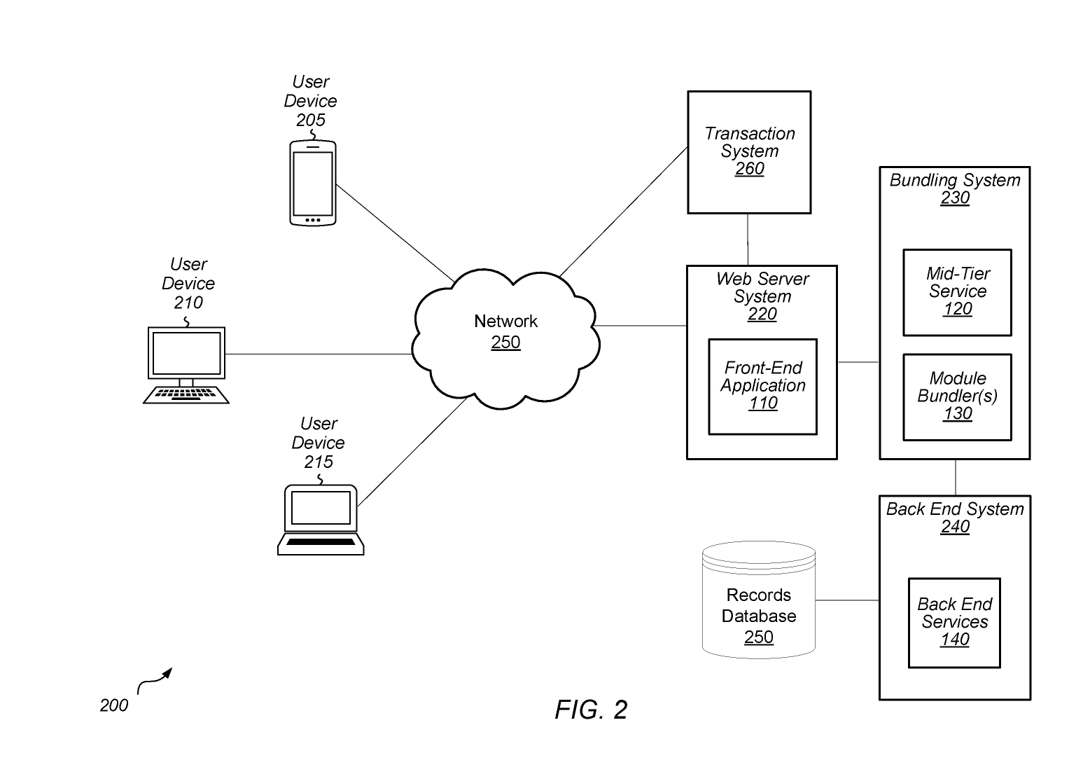

Turning to FIG. 2, a block diagram of a system 200 is shown of a variety of computer systems usable with the software architecture of FIG. 1, according to various embodiments.

As shown, system 200 includes user devices 205, 210, 215, a web server system 220, a bundling system 230, a back end system 240, a records DB (database) 250, and transaction system 260. Note that other permutations of this figure are contemplated (as with all figures). While certain connections are shown (e.g. data link connections) between different components, in various embodiments, additional connections and/or components may exist that are not depicted. Further, components may be combined with one other and/or separated into one or more systems.

User devices 205, 210, and 215 may be any type of computing device. Thus, these devices can be a smartphone, laptop computer, desktop computer, tablet computer, etc. As discussed below, user devices such as 205, 210, and 215 may engage in various actions, including transactions, using transaction system 260. The systems shown may comprise one or more computing devices each having a processor and a memory. Network 250 may comprise all or a portion of the Internet. One or more of web server system 220, bundling system 230, back end system 240, records DB 250, and transaction system 260 may be controlled by an electronic service provider entity, which may be an electronic transaction payment service provider in some instances (allowing for transfer of currency or other quantities, for example).

Transaction system 260 may correspond to an electronic payment service such as that provided by PayPal™. Transaction system 260 may have a variety of associated user accounts allowing users to make payments electronically and to receive payments electronically. A user account may have a variety of associated funding mechanisms (e.g. a linked bank account, a credit card, etc.) and may also maintain a currency balance in the electronic payment account. A number of possible different funding sources can be used to provide a source of funds (credit, checking, balance, etc.). User devices 205, 210, and 215 can be used to access electronic payment accounts such as those provided by PayPal™ In various embodiments, quantities other than currency may be exchanged via transaction system 260, including but not limited to stocks, commodities, gift cards, incentive points (e.g. from airlines or hotels), etc.

Records database (DB) 250 includes records related to various transactions taken by users of transaction system 260. These records can include any number of details, such as any information related to a transaction or to an action taken by a user on a web page or an application installed on a computing device (e.g., the PayPal app on a smartphone). Many or all of the records in records database 250 are transaction records including details of a user sending or receiving currency (or some other quantity, such as credit card award points, cryptocurrency, etc.).

Web server system includes front-end application 110 in the embodiment shown, while bundling system 230 includes mid-tier service 120 and module bundler(s) 130. Back end system 240 includes back end services 140 and is connected to records database 250 in this embodiment. Different systems than those depicted may implement front-end application 110, mid-tier service 120, module bundler(s) 130, and back-end services 140, however, in various embodiments.

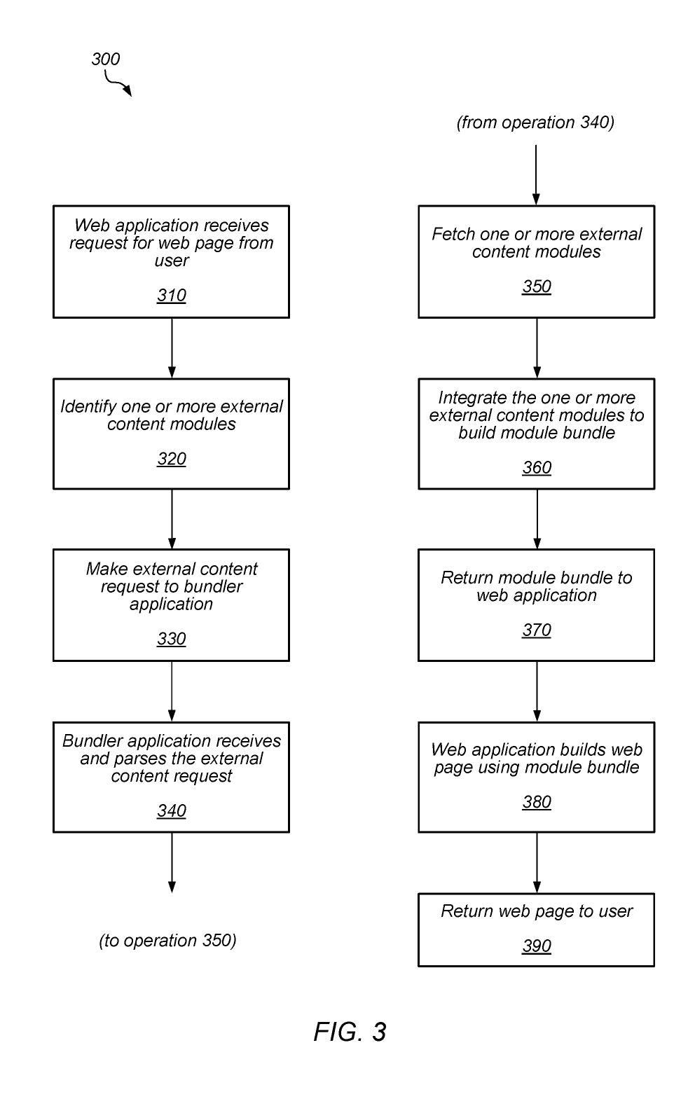

Turning now to FIG. 3, a flow diagram is shown illustrating a method 300 that relates to constructing a web page using a modular web content architecture, according to some embodiments.

Operations described relative to FIG. 3 may be performed, in various embodiments, by any suitable computer system and/or combination of computer systems, including web server system 220, bundling system 230, and/or back end system 240. For convenience and ease of explanation, however, operations described below will simply be discussed relative to web server system 220 and/or bundling system 230. Further, various elements of operations discussed below may be modified, omitted, and/or used in a different manner or different order than that indicated.

In operation 310, web server system 220 receives a request for a first web page from a first user, according to some embodiments. This request may be received via hypertext transfer protocol (HTTP) as a request sent from a user's web browser or another application. (Note that the HTTPS protocol is also included by the term HTTP, as used herein.) The request is received by a web application running on web server system 220 in some embodiments. The web application may be implemented by an instance of a web server such as APACHE™, for example. Thus, the web application can include one or more web pages that have executable code in them, such as JavaScript, PHP, AJAX, etc.

In operation 320, the web application identifies one or more independent renderable content modules required by the web application to build a requested web page, according to some embodiments. (Note that if a content module that is “required” to build a web page is unavailable or has an error, the web page can still be successfully built in various embodiments.)

The requested web page may have one or more configurable display areas that are configured to be populated with dynamic content based on the independent renderable content modules. These configurable display areas may be arranged in columns, rows, and/or any other formation. The web page may also have one or more additional display areas not configured to be populated with content from independent renderable content modules. Thus, a web page could have some particular images, text, control elements, etc., that are not derived from the independent renderable content modules, but are simply part of a menu bar on the top or bottom of the web page, for example.

Note that different portions of a web application (e.g. different web pages within the application) may also have different independent renderable content modules that are used. One web page in a web application may use independent renderable content modules A, B, and C, while another web page uses independent renderable content modules A and D.

Further, even within the same web page in a web application, varied independent renderable content modules can be used based on context. A particular user who is on a specific web page might make use of independent renderable content modules A and B, while a different user might only use independent renderable content module C. Differing requirements for independent renderable content modules can be due to personalization, about which more information can be found in related U.S. patent application Ser. No. 15/835,055.

Identifying one or more independent renderable content modules, in operation 320, can include reading one or more configuration files for a web page and/or web application. A configuration file may specify particular independent renderable content modules to be used when building a web page. A configuration file may also include different contextual rules for building the page as well. For example, a configuration file may specify that if condition #1 is met (such as a user falling into a certain category, the user having an IP address from a particular country or region, or any other number of contexts), then certain independent renderable content modules should be used, while if condition #2 is met, different independent renderable content modules should be used. A configuration file for the above purposes may be a “flat file” in a plain text format, or any other format, and may be incorporated into a rules/decision engine in some embodiments.

In operation 330, the web application makes an external module request to a separate module bundler application, according to various embodiments. This request may be made via an external module request protocol, which can be HTTP and/or another protocol (e.g. JavaScript Object Notation (JSON), Simple Object Access Protocol (SOAP), etc.). Operation 330 can include front-end application 110 making a request to a system that includes mid-tier service 120 and/or module bundler(s) 130 (which, in some instances, may be installed on the same computer system).

The external module request may specify identities of the independent renderable content modules that are being requested, and can also include configuration information for those modules (e.g. parameters that may affect how module bundler(s) 130 assemble the independent renderable content modules).

In operation 340, a module bundler application receives and parses the external module request, according to various embodiments. The module bundler application, as discussed above, may comprise mid-tier service 120 and/or module bundler(s) 130 in some instances, but may be any software and/or hardware application configured to perform the operations discussed herein. Parsing the external module request can include reading the data contained in the request and storing relevant attribute information into appropriate intermediate data structures.

In operation 350, based on the parsing, the module bundler application fetches one or more independent renderable content modules, according to some embodiments. Fetching the independent renderable content modules can include reading one or more files or reading from one or more databases that contain the independent renderable content modules. Each of the independent renderable content modules may include executable code and/or other data. The executable code may be compiled code, intermediate form code such as a Java bytecode, or interpretable script code such as JavaScript.

In some embodiments, fetching in operation 350 includes performing a validation check to ensure that the one or more requested independent renderable content modules are valid. This can include making a registry check (e.g. sending a query to a registry) to see if the status of a module is valid. Instead of a valid status, in some cases, an independent renderable content module could have a status such as deprecated, forbidden, or might simply not exist (to the knowledge of module bundler(s) 130—for example if a module was misidentified with an incorrect name in the external module request 118). Independent renderable content modules can be fetched from storage locally available to bundling system 230, in some instances, or remote storage.

In operation 360, the module bundler application integrates the one or more independent renderable content modules to build a module bundle comprising content for the one or more independent renderable content modules, according to some embodiments. In this context, the content that is included for the one or more independent renderable content modules includes both executable elements as well as data. Thus, “content” in an independent renderable content module can include HTML markup, Javascript or other code, style and formatting information such as CSS (cascading style sheets) information, and text, images, video, audio, etc., for display.

Integrating the one or more independent renderable content modules can include several operations, in various embodiments. One function that may be performed are various back-end data calls (e.g. to back-end services 140). Different databases may need to be accessed to find content for the modules. Such content may be generic (e.g. the same for all users) or may be contextualized content (e.g. account information or other information that is specific to a user or to a group of users, but not one or more other users). These back-end data calls may be made in parallel to speed operations.

Another function that may be performed when integrating one or more independent renderable content modules into a bundle is reading localized content (e.g. as in local content read 136). The independent renderable content module, rather than containing hard-coded text or other content for display, may include references such as strings that refer to particular items. Thus, a string called “Greeting_1” might cause bundling system to check a translation database and pull out the appropriate content based on a user's region or language. The string “Greeting_1” could be replaced with “Welcome to your PayPal account!” for English language users, for example, or instead be replaced with “ [symbol] Bienvenido a su cuenta PayPal!” for Spanish language users. Many different pieces of content within an independent renderable content module may be localized, including images and other content not limited to display text.

Further localization for an independent renderable content module may include changing a layout of the module's content as well. Certain different colors may be used (e.g. in some cultures and regions it may be appropriate to use a black color but not a blue color within a particular context). Content such as text, images, etc., may also appear in different areas when displayed, according to localization rules, as desired. E.g. a rule might specify one layout for English users from the U.S. and the United Kingdom, but a different layout for English users from Australia, if desired. Many different such customizations are possible. During the integration process of operation 360, these various customizations may be performed.

Error handling can also be performed during operation 360 (or elsewhere if desired). For example, a module bundler application may encounter an error condition during integration of a particular one of the plurality of independent renderable content modules. The error encountered can be a variety of different error types, and may be handled appropriately based on that type. In some embodiments, an error encountered when integrating a content module may be a critical or non-critical error. A developer of the independent renderable content module can define the conditions for whether an error is a critical one or not for that module. In some embodiments, a developer of front-end application 110 may also decide whether a particular error in the module is considered to be a critical or non-critical error for the front-end application. In other words, both the module itself and the front-end application can make determinations as to the status (e.g. criticality) of an error, and in some instances an error indicated by the module as non-critical could still be deemed critical by the front-end application.

When an error condition is encountered by bundling system 230, the module bundler application may generate a content error for the particular independent renderable content module according to an external module request protocol. This content error can then be included in the module bundle that is being built. The content error can specify a variety of information, including what portion(s) of the module are affected by the error and whether the error is a critical one (as considered by the module—the front end app may make its own determination in some cases.)

The independent renderable content module, after being integrated, may include various content (e.g. executable code, HTML, text, images, etc.) and be formatted according to any defined external module request protocol. When an error is present, the independent renderable content module may include the error condition information but omit some or all other information. In the case of a critical error (as defined by the independent renderable content module rules) the module may include nothing else besides error information (e.g. no other content). In other instances, the error information may be included along with other content.

In operation 370, the module bundler application returns, to the web application, the module bundle, according to some embodiments. The module bundle may include a list of the requested independent renderable content modules, as integrated during operation 360 (e.g. after processing). As noted above, each of the independent renderable content modules may also have one or more error conditions included within them, if an error was encountered during integration.

In operation 380, a web application (e.g. front-end application 110) iterates through a module bundle to build the web page requested by the user, according to some embodiments.

Iterating through the module bundle may include executing a “view” function that is included within different independent renderable content modules. Such a view function can essentially cause the module to execute various code to render that independent renderable content module appropriately according to its own internal formatting. The web application may place the independent renderable content module within a particular configurable display area on a web page such that the actual appearances of images, text, control elements, etc. within the independent renderable content module is not dictacted by the web application, but whether the module appears on the left or right hand side of the web page (for example) is controlled by the web application. During the iteration process, the web application may take steps such as checking for errors and determining whether the error is critical or non-critical.

In some embodiments, responsive to a content error encountered in a module bundle, a web application may omit a display of a particular independent renderable content module or alternatively, display an error message corresponding to the particular independent renderable content module. For example, if the “user_balance_information” independent renderable content module encounters a critical error (e.g. there is no data for the module other than the error information), the web application may render an error message on the web page for the user, such as “ERROR: Unable to load balance information at this time.”

If the “user_balance_information” independent renderable content module encounters a non-critical error, a different message could be displayed. For example, consider a scenario where a user has a checking account, a savings account, and a 401(k) retirement account. Ordinarily, the user_balance_information module might return a dollar amount for each of these accounts, but during integration of the module, an error may have been encountered when querying the 401(k) account (which could be part of a different database than the checking and savings accounts). In this example, the error may be a non-critical one. The rendered content for the module might be “Savings account balance: $1,000; Checking account balance: $500; 401(k) account balance: currently unavailable.” In another example, an error for a promotional message (e.g. an advertisement or offer) might cause that portion of the independent renderable content module to be omitted from display. In other instances, an error in an independent renderable content module may result in the module being omitted entirely from the web page. A critical error in the module, for example, may cause a web application to simply not attempt to display the module's content within the web page. As will be appreciated, many different scenarios with a non-critical error that affects displayed content for an independent renderable content module are possible.

The web application, when iterating through the module bundle, may also review error information to determine whether in error in a particular independent renderable content module represents a critical error to the application itself. This may depend on the web page and the current context for the web application. For example, consider a web application that allows a user to transfer money from a checking account to a savings account. This web application (or portion thereof) may use the user_balance_information module to display the account balances so that the user can see how much money is available to move from the checking account. If the user_balance_information has an error such that the user is only able to see his savings account balance, but not a checking balance, then the app has encountered a critical error in this example: it is imperative that the user know how much money is in the checking account balance if he is to able to use it as a source of funds for the transfer. Thus, even if the user_balance_information has (from the module's perspective) a non-critical error (e.g. the savings information is still available), the web application itself may deem this a critical error and alter the content of the web page to reflect this appropriately (e.g., a message such as “ERROR: unable to make a transfer from checking account at this time.”). In an instance such as this, the web application can be said to disable one or more functionalities of the web application that are separate from the particular independent renderable content module (e.g. the user_balance_information module) that had the content error.

In other contexts, however, such as when a user is simply being displayed account balance information for informational purposes, the error in the user_balance_information module may be non-critical from the perspective of the web application. Again, many different related scenarios are possible, and web applications are not limited to only such financial transactions and may be used for many different purposes. Rather, the techniques of this disclosure broadly apply to an architecture that can be used to effectively handle content for many possible types of web applications and independent renderable content modules.

Likewise, in response to a content error in an independent renderable content module being a non-critical application error, the web application may maintain all other functionalities of the web application that are separate from the particular independent renderable content module that had the content error. Continuing the example above, if a web application offers functionalities that are not impacted by missing checking account balance information, all those functionalities may continue to be available to the user, and content for those functionalities (including control elements on the web page such as forms, menus, hyperlinks, etc.) may be rendered into the web page by the web application.

In operation 390, the web application returns the web page to the user, according to some embodiments. This operation may include making an HTTP transmission to the user responsive to that user's earlier request for a web page. The web page can be transmitted back to a user's web browser (or other requesting application).

### Computer-Readable Medium

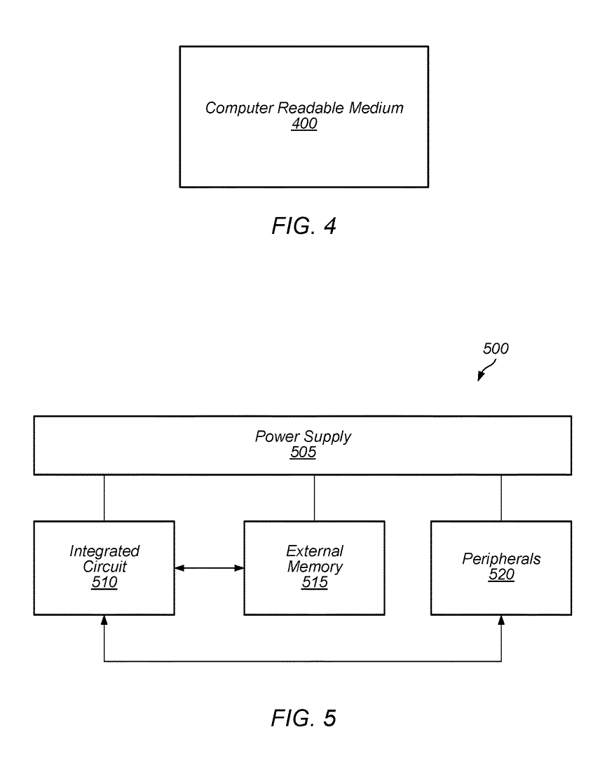

Turning to FIG. 4, a block diagram of one embodiment of a computer-readable medium 400 is shown. This computer-readable medium may store instructions corresponding to the operations of FIG. 3 and/or any techniques described herein. Thus, in one embodiment, instructions corresponding to web server system 220, bundling system 230, and/or any other system may be stored on computer-readable medium 400.

Note that more generally, program instructions may be stored on a non-volatile medium such as a hard disk or FLASH drive, or may be stored in any other volatile or non-volatile memory medium or device as is well known, such as a ROM or RAM, or provided on any media capable of staring program code, such as a compact disk (CD) medium, DVD medium, holographic storage, networked storage, etc. Additionally, program code, or portions thereof, may be transmitted and downloaded from a software source, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a server or server system such as, for example, in C, C+, HTML, Java, JavaScript, or any other scripting language, such as VBScript. Note that as used herein, the term “computer-readable medium” refers to a non-transitory computer readable medium.

### Computer System

In FIG. 5, one embodiment of a computer system 500 is illustrated. Various embodiments of this system may be web server system 220, bundling system 225, back end system 240, transaction system 260, or any other computer system as discussed above and herein.

In the illustrated embodiment, system 500 includes at least one instance of an integrated circuit (processor) 510 coupled to an external memory 515. The external memory 515 may form a main memory subsystem in one embodiment. The integrated circuit 510 is coupled to one or more peripherals 520 and the external memory 515. A power supply 505 is also provided which supplies one or more supply voltages to the integrated circuit 510 as well as one or more supply voltages to the memory 515 and/or the peripherals 520. In some embodiments, more than one instance of the integrated circuit 510 may be included (and more than one external memory 515 may be included as well).

The memory 515 may be any type of memory, such as dynamic random access memory (DRAM), synchronous DRAM (SDRAM), double data rate (DDR, DDR2, DDR6, etc.) SDRAM (including mobile versions of the SDRAMs such as mDDR6, etc., and/or low power versions of the SDRAMs such as LPDDR2, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit 510 in a chip-on-chip configuration, a package-on-package configuration, or a multi-chip module configuration.

The peripherals 520 may include any desired circuitry, depending on the type of system 500. For example, in one embodiment, the system 500 may be a mobile device (e.g. personal digital assistant (PDA), smart phone, etc.) and the peripherals 520 may include devices for various types of wireless communication, such as wife, Bluetooth, cellular, global positioning system, etc. Peripherals 520 may include one or more network access cards. The peripherals 520 may also include additional storage, including RAM storage, solid state storage, or disk storage. The peripherals 520 may include user interface devices such as a display screen, including touch display screens or multitouch display screens, keyboard or other input devices, microphones, speakers, etc. In other embodiments, the system 500 may be any type of computing system (e.g. desktop personal computer, server, laptop, workstation, net top etc.). Peripherals 520 may thus include any networking or communication devices necessary to interface two computer systems.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed by various described embodiments. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims. The techniques disclosed above are specifically contemplated for use in combination with the techniques disclosed in U.S. application Ser. No. 15/835,055 in various embodiments and may be combined in any suitable way (e.g. using content personalization within the web content architecture disclosed herein).

What is claimed is:

1. A method of using a modular web content architecture, comprising:
receiving, at a web application installed on a computer system, a request for a web page from a user;
the web application identifying a plurality of independent renderable content modules required by the web application to build the web page;
the web application making an external module request, via an external module request protocol, to a separate module bundler application;
the module bundler application receiving and parsing the external module request;
based on the parsing, the module bundler application fetching the plurality of independent renderable content modules;
the module bundler application integrating the plurality of independent renderable content modules to build a module bundle comprising content for the plurality of independent renderable content modules;
the module bundler application returning, to the web application, the module bundle;
the web application iterating through the module bundle to build the web page; and
the web application returning the web page to the user.

2. The method of claim 1, further comprising:
the module bundler application encountering an error condition during integration of a particular one of the plurality of independent renderable content modules;
the module bundler application generating a content error for the particular independent renderable content module according to the external module request protocol; and
the content bundler including the content error in the module bundle.

3. The method of claim 2, further comprising:
responsive to the content error, the web application omitting a display of the particular independent renderable content module or alternatively displaying an error message corresponding to the particular independent renderable content module.

4. The method of claim 2, further comprising:
the web application recognizing the content error in the module bundle and determining whether the content error represents a critical application error or a non-critical application error.

5. The method of claim 3, further comprising:
in response to the content error being a critical application error, the web application disabling one or more functionalities of the web application that are separate from the particular independent renderable content module that had the content error.

6. The method of claim 3, further comprising:
in response to the content error being a non-critical application error, the web application maintaining all other functionalities of the web application that are separate from the particular independent renderable content module that had the content error.

7. The method of claim 1, wherein the computer system comprises at least a first computing device and a second computing device that are configured to connect to one another via a network connection.

8. The method of claim 1, wherein the external module request is made to the module bundler application via a mid-tier service application.

9. The method of claim 1, wherein the external module request crosses a hyper-text transfer protocol (HTTP) boundary.

10. The method of claim 1, wherein identifying the plurality of independent renderable content modules comprises accessing a configuration file with identifying information for each of the plurality of independent renderable content modules.

11. The method of claim 1, wherein the external module request protocol is JavaScript Object Notation (JSON).

12. A non-transitory computer-readable medium having stored thereon instruction executable by a modular web content system to cause the system to perform operations comprising:
receiving, at a module bundler application, an external module request made by a web application via an external module request protocol, the external module request being made responsive to a user request for a web page;
the module bundler application receiving and parsing the external module request;
based on the parsing, the module bundler application identifying a plurality of independent renderable content modules required by the web application to build the web page;
fetching the plurality of identified independent renderable content modules;
the module bundler application integrating the plurality of independent renderable content modules to build a module bundle comprising content for the plurality of independent renderable content modules; and
the module bundler application returning, to the web application, the module bundle.

13. The non-transitory computer-readable medium of claim 12, wherein the operations further comprise:
the module bundler application encountering an error condition during integration of a particular one of the plurality of independent renderable content modules;
the module bundler application generating a content error for the particular independent renderable content module according to the external module request protocol; and
the content bundler including the content error in the module bundle.

14. The non-transitory computer-readable medium of claim 12, wherein the external module request protocol complies with hypertext transfer protocol (HTTP) specifications.

15. The non-transitory computer-readable medium of claim 12, wherein returning the module bundle to the web applications comprises transmitting the module bundle to a separate computing device.

16. A system, comprising
a processor;
a network interface device; and
a non-transitory computer-readable medium having stored thereon instruction executable to cause the system to perform operations comprising:
receiving, at a web application, a request for a web page from a user;
identifying a plurality of independent renderable content modules required by the web application to build the web page;
the web application making an external module request, via an external module request protocol, to a separate module bundler application;
the module bundler application receiving and parsing the external module request;
based on the parsing, the module bundler application fetching the plurality of independent renderable content modules;
the module bundler application integrating the plurality of independent renderable content modules to build a module bundle comprising content for the plurality of independent renderable content modules;
the module bundler application returning, to the web application, the module bundle;
the web application iterating through the module bundle to build the web page; and
the web application returning the web page to the user.

17. The system of claim 16, wherein the operations further comprise:
successfully building the web page in the event of one of the plurality of independent renderable content modules being unavailable, wherein the unavailable independent renderable content module is non-critical to the web application.

18. The system of claim 16, wherein the operations further comprise:
processing a transaction including a transfer of currency via the web application, wherein the web page is usable to initiate the transfer of currency.

19. The system of claim 16, wherein identifying the plurality of independent renderable content modules comprises accessing a configuration file with identifying information for each of the plurality of independent renderable content modules.

20. The system of claim 16, wherein the system comprises at least a first computing device and a second computing device that are configured to connect to one another via a network connection.
